(19) United States
(12) Patent Application Publication
(10) Pub. No.: US 2018/0170261 A1
(43) Pub. Date: Jun. 21, 2018

(54) SYSTEM AND METHOD FOR ACTIVATING A REAR-FACING CAMERA

(71) Applicant: Honda Motor Co., Ltd., Tokyo (JP)

(72) Inventors: Douglas KALTENMARK, Powell, OH (US); Michael BINFET, Bellefontaine, OH (US); Erik F. DE ALMEIDA, Dublin, OH (US)

(21) Appl. No.: 15/382,912

(22) Filed: Dec. 19, 2016

(51) Int. Cl. B60R 1/04; B60R 11/04; B60R 1/12; H04N 5/232; H04N 7/18; G06K 9/00

(52) U.S. Cl. CPC B60R 1/04; B60R 11/04; B60R 1/12; B60R 2300/8046; H04N 7/181; G06K 9/00838; H04N 5/23293

(57) ABSTRACT

A rear view display system and method for a motor vehicle is having a rearview mirror providing an exterior rear view of the motor vehicle is disclosed. The system includes a camera located at a rear of the motor vehicle, a display within an interior of the motor vehicle, a sensor for detecting an obstruction obstructing the exterior rear view of the motor vehicle, and a control circuit adapted to send a video feed from the camera to the display when the obstruction is detected. The method includes the steps of detecting an obstruction obstructing the exterior rear view of the motor vehicle, and sending a video feed from the camera to the display when the obstruction is detected.

### TECHNICAL FIELD

The embodiments described herein are related to systems for providing rear views out of a motor vehicle when a rear view mirror is obstructed.

### BACKGROUND

For several years, motor vehicles have included a small video screen that shows the image of a rear backup camera. This camera turns on when the transmission is put into reverse, and turns off when the transmission is shifted out of reverse. Newer motor vehicles have applied an interior rearview mirror with a full screen video screen capable of displaying a rear view of the motor vehicle that is activated by a toggle lever.

There are instances, however, when the rear view as viewed in the rearview mirror can be obstructed. One example of such a scenario may occur when hauling larger objects in the trunk, and the trunk needs to be left open while driving. Another example is for a motor vehicle with a convertible top that may raised or lowered during low-speed operation of the motor vehicle. Yet another example may be a motor vehicle with two or three rows behind the front row that are occupied by passengers, potentially with head rests in a raised position that block the rear view of the motor vehicle as observed in the rearview mirror.

### APPLICATION SUMMARY

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

According to one aspect a rear view display system for a motor vehicle having a rearview mirror providing an exterior rear view of the motor vehicle includes a camera located at a rear of the motor vehicle, a display within an interior of the motor vehicle, a sensor for detecting an obstruction obstructing the exterior rear view of the motor vehicle, and a control circuit adapted to send a video feed from the camera to the display when the obstruction is detected.

According to another aspect, a method of operating a rear view display system for a motor vehicle having a rearview mirror providing an exterior rear view of the motor vehicle, a camera located at a rear of the motor vehicle, and a display within an interior of the motor vehicle is disclosed. The method includes the steps of detecting an obstruction obstructing the exterior rear view of the motor vehicle, and sending a video feed from the camera to the display when the obstruction is detected.

### BRIEF DESCRIPTION OF THE DRAWINGS

FIG. 1 is a perspective view of an embodiment of a portion an interior of a motor vehicle.

FIG. 2 is a side view of a motor vehicle.

FIG. 3 is a rear view of a motor vehicle.

FIG. 4 is a perspective view of an alternate embodiment of a portion of a motor vehicle.

FIG. 5 is a circuit diagram of an embodiment of the camera and display system.

FIG. 6 is a view of an embodiment of a view out the rear of a motor vehicle.

FIG. 7A is side view of one embodiment of a motor vehicle with a trunk lid.

FIG. 7B is a side view of an alternate embodiment of a motor vehicle with a tailgate.

FIG. 8 is a side view of an interior of a motor vehicle.

FIG. 9 is a side view of an embodiment of a motor vehicle with a convertible top.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

Currently, a motor vehicle 100 may include a display 102, usually a built in LCD display, that automatically shows the view from a camera 200, typically located above the rear license plate 202, when the motor vehicle 100 is put in reverse. The embodiments described herein are related applications for using this camera 200 to automatically show the rear view 204, as the motor vehicle 100 is in a forward gear, when an obstruction is detected that blocks the rear view 204 of the driver 104 in the rearview mirror 106.

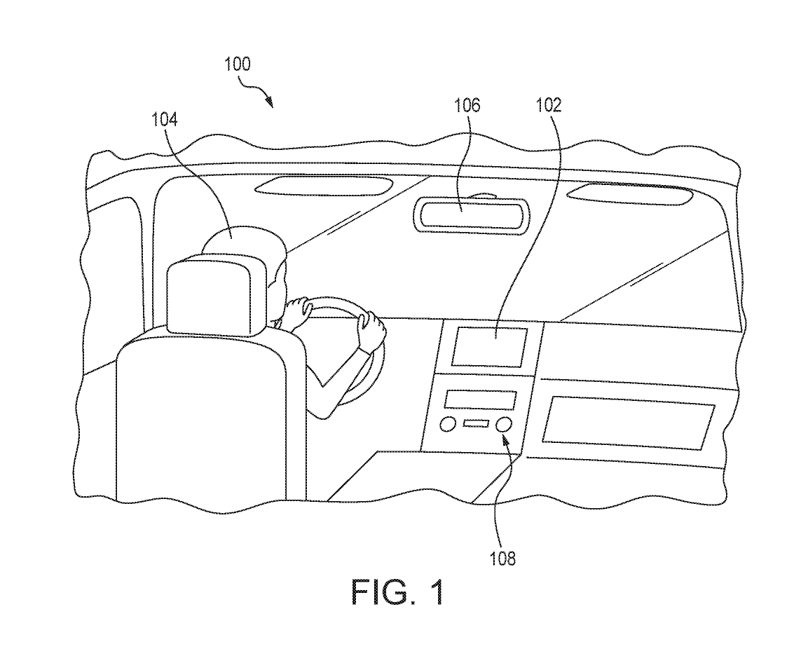

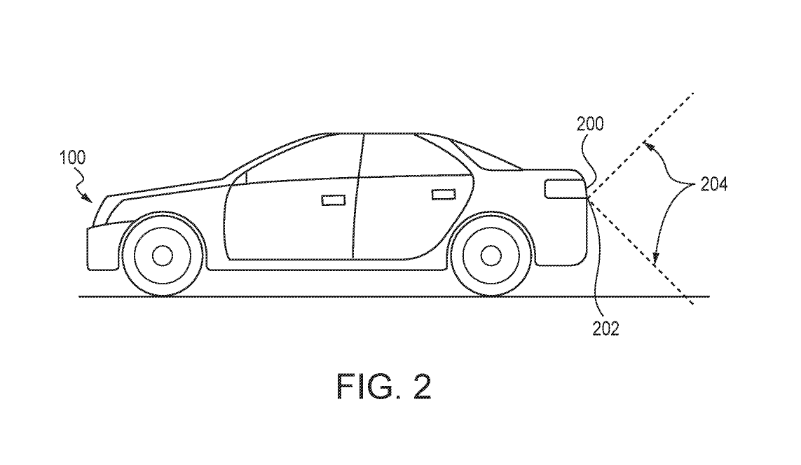

Referring now to the Figures, FIGS. 1-2 shows a motor vehicle 100 with a rear camera 200. When the motor vehicle 100 is in a reverse gear, the driver 104 can see the rear view 204 through the rear view display 102. As illustrated in FIG. 1, the rear view display 102 is built into a center stack 108 of the motor vehicle 100. This display 102 comes on automatically whenever the motor vehicle 100 is shifted into a reverse gear. In this embodiment, the display 102 may be shared with other functions in the motor vehicle 100, such in-vehicle diagnostic system, a navigation system, an in-vehicle entertainment system, or any other functions that may require providing information to the driver 104

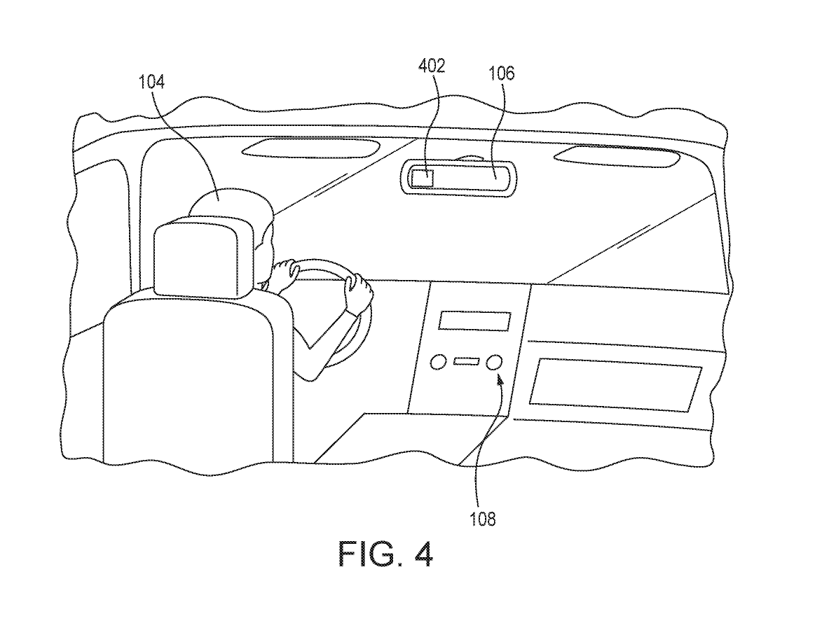

As shown in FIG. 4, in an alternate embodiment, the rear view display 402 may be built into the rearview mirror 106 without any change in functionality. The continuing discussion below will describe the operation of the embodiment of FIG. 1, but will also apply to the operation of the embodiment in FIG. 4. Although illustrated occupying a portion of the rearview mirror 106, the rear view display 402 may also occupy the entire area of the rearview mirror 106.

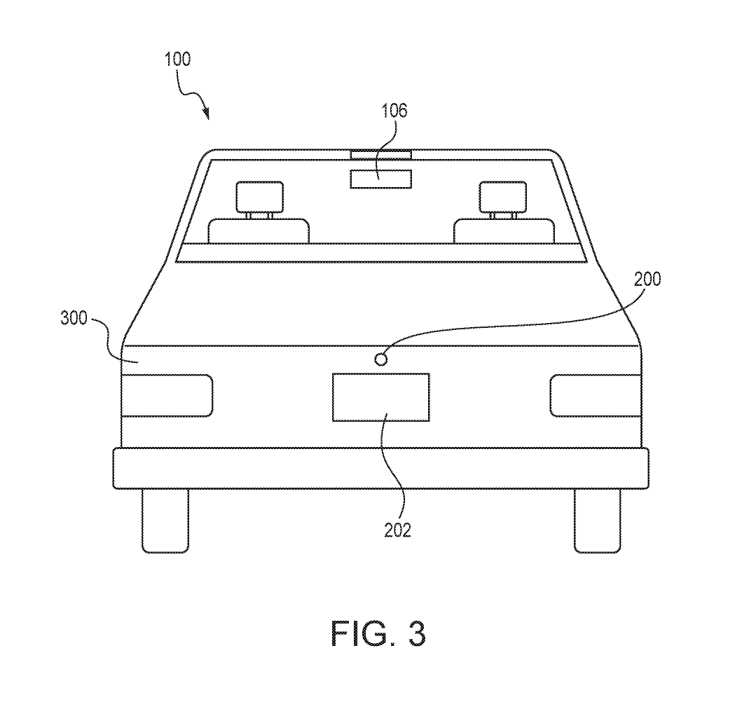

Referring again to FIGS. 2-3, the camera 200 is typically located in the rear 300 of the motor vehicle 100, just above the rear license plate 202. The camera 200 sends its video signal to a display 102 integrated into a center stack 108 of the motor vehicle 100.

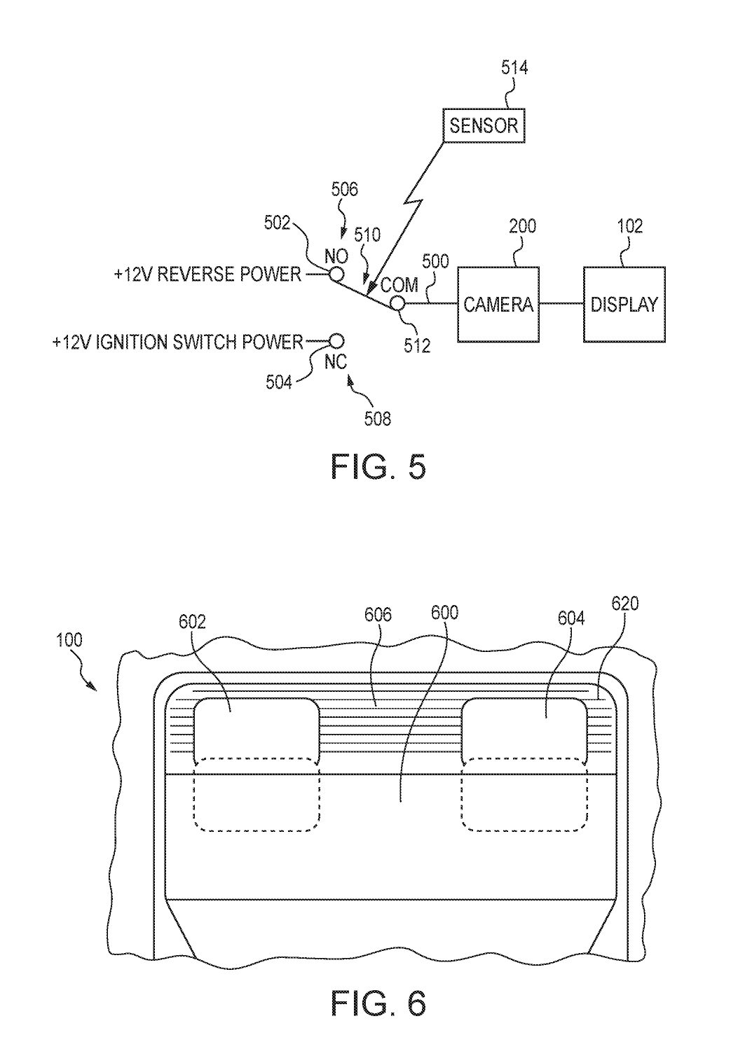

FIG. 5 illustrates a schematic view one embodiment of a camera 200 and an operating circuit. The camera 200 is connected to the display 102. The trigger wire 500 for this camera 200 can be powered by either by +12V reverse power 502 or +12V ignition switched power 504. In the configuration of FIG. 3, the +12V reverse power 502 is connected to the normally open (NO) lead 506 on the switch 510, and the +12V ignition switched power 504 is connected to the normally closed (NC) lead 508 on the switch 510. In this configuration, the common (COM) lead 512 is connected to the trigger wire 500 for the camera 200. When a sensor 514 is not detecting an obstruction, the switch 510 is activated, the circuit for +12V reverse power 502 is completed and the circuit for +12V ignition switched power 504 is broken. Thus, the rear view display 102 only comes on when the motor vehicle 100 is put in reverse.

When an obstruction is detected, the switch 510 is actuated, the circuit for +12V reverse power 502 is broken and the circuit for +12V ignition switched power 504 is completed. Thus, the rear view display 102 is on when an obstruction is detected, and a video feed from the camera 200 is displayed on the display 102. When the motor vehicle 100 is both in reverse and an obstruction is detected, the camera 200 is still on and receives power from the +12 ignition switched power 504 source. Any other suitable operating circuit and switching system known to one skilled in the art may be used.

The switch 510 is activated by a sensor 514 when the sensor 514 detects the presence of an object creating an obstruction. As illustrated in FIG. 6, in one embodiment, the sensor 514 may be located in a passenger row of seats 600 in the motor vehicle 100 to detect when a headrest 602, 604 is raised, thereby blocking a view, or a portion of the view, out the rear window 606 of the motor vehicle 100. In FIG. 6, when the headrests 602, 604 are lowered, as viewed in dotted lines, the view out the rear window 606 is obstruction-free. However, if the headrests 602, 604 are raised, as illustrated in solid lines, the view out the rear window 606 is obstructed. The sensor 514 may be activated with the raising of the headrests 602, 604 to activate the switch 510 to engage the rear camera 200.

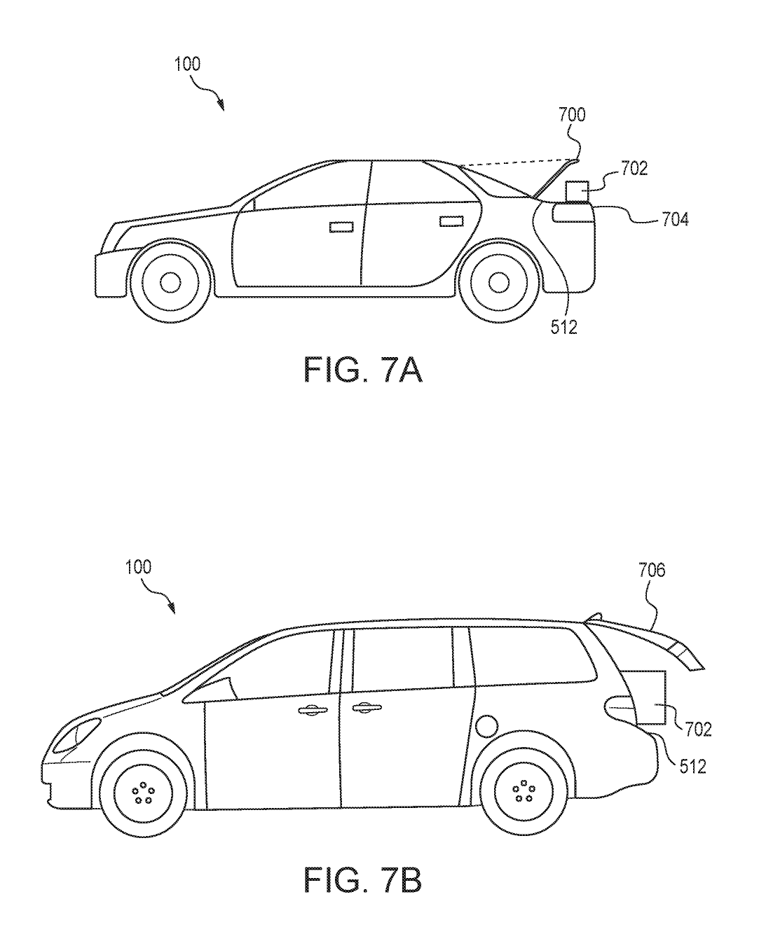

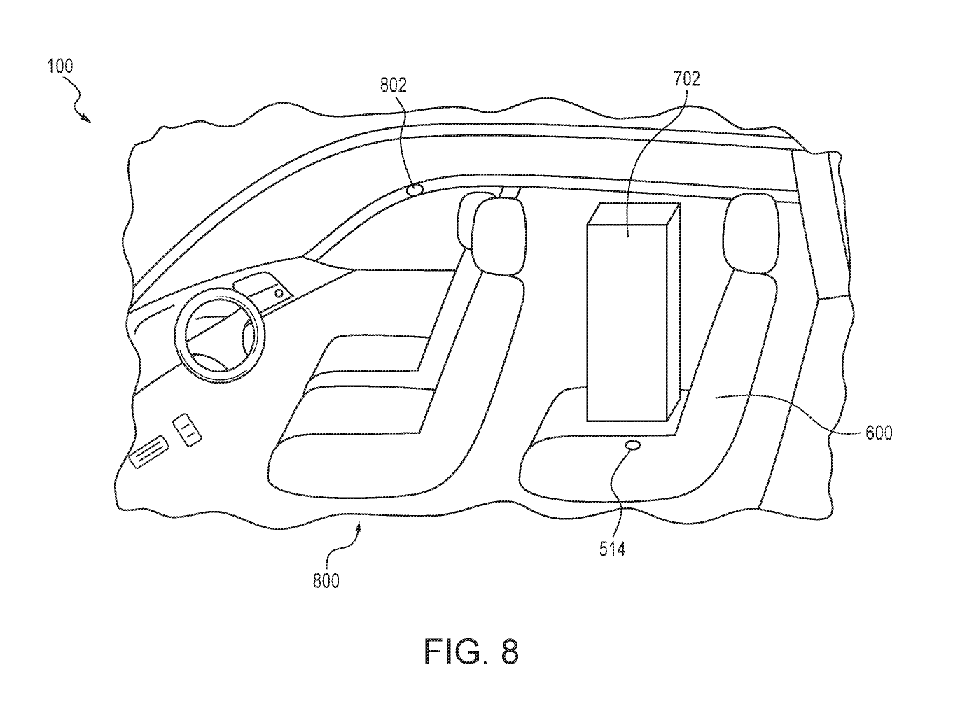

FIG. 7A illustrates an alternate embodiment where the sensor 514 is a proximity sensor used to determine if a rearward facing door, such as the trunk lid 700, is open or closed. As illustrated, an open trunk lid 700, which may occur during transportation of a large object 702 in the trunk 704 of the motor vehicle 100, may obstruct the rear view 706, the boundary of which is depicted by dotted lines, out of the motor vehicle 100, as depicted in FIG. 7A. In this situation the sensor 514 may be a trigger switch of the type known to those skilled in the art, such as a single pole double throw reed switch. Other types of sensors 512 or switches 510 that may be used include any simple on/off (either mechanical or electrical) switches, Hall effect sensors, or any other type of sensor 514 capable of determining the open or closed state of the trunk lid 700. In an alternate embodiment, the rearward facing door may be a rear tailgate 706 of the type commonly found in sport utility vehicles (SUV), illustrated in FIG. 7B.

FIG. 8 illustrates yet another embodiment where a sensor 514 detects the presence of an obstruction 702 in the interior 800 of the motor vehicle 100 that may obstruct the rear view out the rear window 606 of the motor vehicle 100. The sensor 514 may be a pressure sensor located in the rear seat 600 of the motor vehicle 100 that is activated when an obstruction 702, which may be a person or large object, is seated or placed in the seat 600. The sensor may be any other type of sensor, such as a capacitance sensor, capable of detecting the presence of an obstruction in the seat to know to one skilled in the art.

Either alternatively or additionally, the motor vehicle 100 may include an internal occupant detection system utilizing a camera 802 that is capable of detecting the presence of obstruction 702 in the rearward seats 600 of the motor vehicle 100 that may obstruct the view out the rear window 606 of the motor vehicle 100. One example may include an image based occupant classification system, such as the type described in U.S. Pat. No. 8,036,795, which is incorporated fully herein by reference. When the internal occupant detection system, utilizing images from camera 802, identifies an obstruction 702 creating an obstructed rear view, the internal occupant detection system may activate the switch 510 to engage the rear camera 200. Any other image-based or proximity sensors known to those skilled in the art may also be used. The obstruction 702 may be located in a rearward seat 600, in the rear window 606, or anywhere else that may obstruct the view out the rear window 606 of the motor vehicle 100.

With continuing reference to FIG. 8, the sensor 514 may detect the presence of condensation, either in liquid or ice form, on the rear window 606 of the motor vehicle 100. The condensation may be detected by a camera 802 of an internal occupant detection system. The condensation may also be detected by a sensor on the rear window 606 of the motor vehicle 100. In yet another embodiment, the switch 510 may be actuated when the rear window defroster 620, illustrated in FIG. 6, is operated by the driver 104 of the motor vehicle 100.

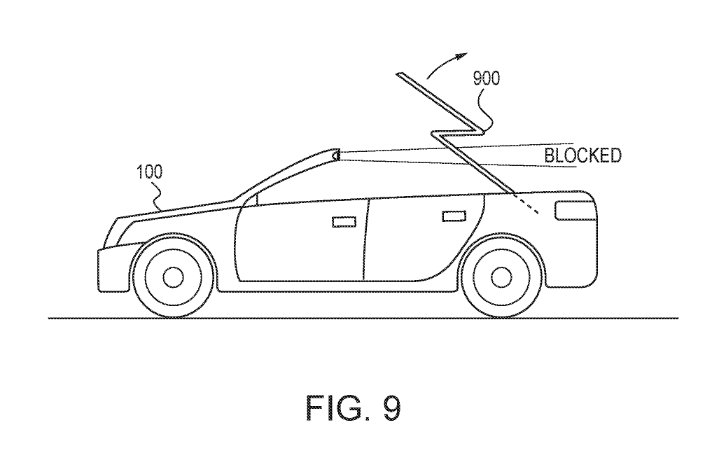

FIG. 9 illustrates an alternate embodiment when the switch 510 activating the camera 200 and the display 102 is actuated when a convertible top 900 of the motor vehicle 100 is either raised or lowered, thereby allowing the driver to see behind the motor vehicle 100 when the convertible top 900 obstructs the rear view. The switch 510 may be activated by a sensor 514 that detects movement of the convertible top 900. The switch 510 may also be activated by activation of the motor responsible for raising and lowering the convertible top 900. Additionally, the convertible top 900 may include a rear window 606 that is smaller than a rear window 606 in a conventional, non-convertible motor vehicle 100. In such a case, display 102 may be activated whenever the convertible top 900 is in a closed position.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments, which is set forth in the claims.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

What is claimed is:

1. A rear view display system for a motor vehicle having a rearview mirror providing an exterior rear view of the motor vehicle, comprising:
a camera located at a rear of the motor vehicle;
a display within an interior of the motor vehicle;
a sensor for detecting an obstruction obstructing the exterior rear view of the motor vehicle; and
a control circuit adapted to display a video feed from the camera on the display when the obstruction is detected.

2. The rear view display system of claim 1 wherein the sensor is an occupant detection sensor.

3. The rear view display system of claim 2 wherein the occupant detection sensor is disposed within a rear seat of the motor vehicle.

4. The rear view display system of claim 2 wherein the occupant detection sensor is an internal camera.

5. The rear view display system of claim 1 wherein the sensor is a proximity sensor.

6. The rear view display system of claim 5 wherein the proximity sensor is located in a rearward facing door of the motor vehicle.

7. The rear view display system of claim 6 wherein the rearward facing door is a trunk lid.

8. The rear view display system of claim 6 wherein the rearward facing door is a tailgate.

9. The rear view display system of claim 1 wherein the camera and display are activated to show the video feed when the sensor detects a raising or lowering of a convertible top.

10. The rear view display system of claim 1 wherein the sensor detects when a headrest disposed within a rear seat of the motor vehicle is in a raised position.

11. The rear view display system of claim 1 wherein the sensor detects condensation on a rear window of the motor vehicle.

12. The rear view display system of claim 1 wherein the sensor detects operation of a rear window defroster.

13. The rear view display system of claim 1 wherein the display is disposed in the rearview mirror.

14. The rear view display system of claim 1 wherein the display is disposed in a center stack of the motor vehicle.

15. A method of operating a rear view display system for a motor vehicle having a rearview mirror providing an exterior rear view of the motor vehicle, a camera located at a rear of the motor vehicle, and a display within an interior of the motor vehicle, the method comprising the steps of:
detecting an obstruction obstructing the exterior rear view of the motor vehicle; and
sending a video feed from the camera to the display when the obstruction is detected.

16. The method of claim 15 wherein the step of detecting an obstruction further comprises:
detecting an open rearward facing door.

17. The method of claim 15 wherein the step of detecting an obstruction further comprises:
detecting an occupant in a rear seat of the motor vehicle.

18. The method of claim 17 wherein the step of detecting an occupant further comprises the step of:
detecting an occupant with an internal camera.

19. The method of claim 17 wherein the step of detecting an occupant further comprises the step of:
detecting an occupant with a seat sensor disposed in the rear seat.

20. The method of claim 15 wherein the step of detecting an obstruction further comprises:
detecting a headrest in a raised position in a rear seat of the motor vehicle.

21. The method of claim 15 wherein the step of detecting an obstruction further comprises:
detecting a position of a convertible top.

22. The method of claim 15 wherein the step of detecting an obstruction further comprises:
detecting condensation on a rear window of the motor vehicle.

23. The method of claim 15 wherein the step of detecting an obstruction further comprises:
detecting operation of a rear window defroster.

24. The method of claim 15 wherein the step of sending the video feed further comprises the step of:
sending the video feed from the camera to the display disposed in the rearview mirror when the obstruction is detected.

25. The method of claim 15 wherein the step of sending the video feed further comprises the step of:
sending the video feed from the camera to the display disposed in a center stack of the motor vehicle when the obstruction is detected.
